(19) United States
(12) Patent Application Publication
(10) Pub. No.: US 2025/0251616 A1
(43) Pub. Date: Aug. 7, 2025

(54) STATIC MULTIVIEW DISPLAY AND METHOD USING MICRO-SLIT SCATTERING ELEMENTS

(71) Applicant: LEIA Inc., Menlo Park, CA (US)

(72) Inventors: David A. Fattal, Mountain View, CA (US); Ming Ma, Menlo Park, CA (US); Colton Bukowsky, Menlo Park, CA (US); Thomas Hoekman, Menlo Park, CA (US)

(21) Appl. No.: 18/855,032

(22) PCT Filed: Apr. 9, 2022
(86) PCT No.: PCT/US2022/024164

§ 371 Date: Oct. 8, 2024

(51) Int. Cl. G02B 30/33; F21V 8/00; G02B 30/32

(52) U.S. Cl. CPC G02B 30/33; G02B 6/0036; G02B 30/32

(57) ABSTRACT

A static multiview display and method of static multiview display operation include micro-slit scattering elements configured to reflectively scatter out the guided light from the light guide as a corresponding plurality of directional light beams that encode view pixels of a static multiview image. The static multiview display includes a light guide configured to guide light and a plurality of the micro-slit scattering elements, each micro-slit scattering element of the micro-slit scattering element plurality is configured to reflectively scatter out a different one of directional light beams having a relative intensity and a direction that encode a corresponding view pixel of the static multiview image. The micro-slit scattering elements each comprise a sloped reflective sidewall having a slope angle that is tilted away from the propagation direction of the guided light that provides the reflective scattering.

### CROSS-REFERENCE TO RELATED APPLICATION

N/A

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Examples of active displays include CRTs, PDPs and OLEDs/AMOLEDs. Example of passive displays include LCDs and EP displays. Passive displays, while often exhibiting attractive performance characteristics including, but not limited to, inherently low power consumption, may find somewhat limited use in many practical applications given the lack of an ability to emit light.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements.

FIG. 1 illustrates a perspective view of a multiview display in an example according to an embodiment consistent with the principles described herein.

FIG. 2 illustrates a graphical representation of the angular components of a light beam having a particular principal angular direction corresponding to a view direction of a multiview display in an example, according to an embodiment consistent with the principles described herein.

FIG. 3A illustrates a plan view of a static multiview display in an example, according to an embodiment consistent with the principles described herein.

FIG. 3B illustrates cross-sectional view of a portion of a static multiview display in an example, according to an embodiment consistent with the principles described herein.

FIG. 3C illustrates perspective view of the portion of a static multiview display illustrated in FIG. 3B in an example, according to an embodiment consistent with the principles described herein.

FIG. 3D illustrates a perspective view of a static multiview display in an example, according to an embodiment consistent with the principles described herein.

FIG. 4A illustrates a cross-sectional view of a portion of a static multiview display in an example, according to an embodiment of the principles described herein.

FIG. 4B illustrates a cross-sectional view of a portion of a static multiview display in an example, according to another embodiment of the principles described herein.

FIG. 4C illustrates a cross-sectional view of a portion of a static multiview display in an example, according to another embodiment of the principles described herein.

FIG. 5 illustrates a cross-sectional view of a portion of a static multiview display including a micro-slit scattering element in an example, according to an embodiment consistent with the principles described herein.

FIG. 6 illustrates a perspective view of a curved micro-slit scattering element in an example, according to an embodiment consistent with the principles described herein.

FIG. 7A illustrates a plan view of a static multiview display 100 including spurious reflection mitigation in an example, according to an embodiment consistent with the principles described herein.

FIG. 7B illustrates a plan view of a static multiview display including spurious reflection mitigation in an example, according to another embodiment consistent with the principles described herein.

FIG. 8A illustrates a plan view of a static multiview display in an example, according to an embodiment consistent with the principles described herein.

FIG. 8B illustrates a plan view of the static multiview display of FIG. 8A in another example, according to an embodiment consistent with the principles described herein.

FIG. 9 illustrates a block diagram of a static multiview display in an example, according to another embodiment consistent with the principles described herein.

FIG. 10 illustrates a flow chart of a method of static multiview display operation in an example, according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide display of a static or quasi-static three-dimensional (3D) or multiview image. In particular, embodiments consistent with the principles described herein provide a static multiview display that employs a plurality of micro-slit scattering elements configured to emit light comprising a similar plurality of directional light beams that encode view pixels of a multiview image displayed by the static multiview display. According to various embodiments, directional light beams emitted the micro-slit scattering elements of the micro-slit scattering element plurality have individual intensities and directions corresponding to view pixels in views of the static multiview image being displayed. According to various embodiments, the individual intensities and, in some embodiments, the individual directions of the directional light beams are predetermined or ‘fixed’ by reflection characteristics of the micro-slit scattering elements. As such, the displayed multiview image may be referred to as a static or in some embodiments a ‘quasi-static’ multiview image. Uses of static multiview displays described herein include, but are not limited to, mobile telephones (e.g., smart phones), watches, tablet computes, mobile computers (e.g., laptop computers), personal computers and computer monitors, automobile display consoles, cameras displays, and various other mobile as well as substantially non-mobile display applications and devices.

Herein, a ‘multiview display’ is defined as an electronic display or display system configured to provide different views of a multiview image in different view directions. A ‘static multiview display’ is a defined as a multiview display configured to display a predetermined or fixed (i.e., static) multiview image, albeit as a plurality of different views. A ‘quasi-static multiview display’ is defined herein as a static multiview display that may be switched between different fixed multiview images or between a plurality of multiview image states, typically as a function of time. Switching between the different fixed multiview images or multiview image states may provide a rudimentary form of animation, for example. Further, as defined herein, a quasi-static multiview display is a type of static multiview display. As such, no distinction is made between a purely static multiview display or image and a quasi-static multiview display or image, unless such distinction is necessary for proper understanding.

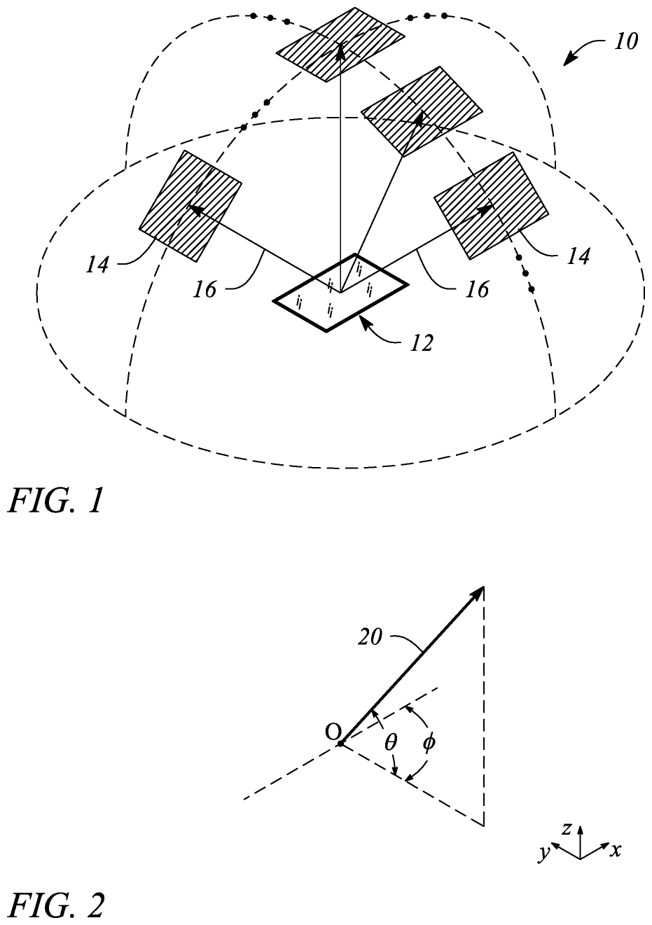

FIG. 1 illustrates a perspective view of a multiview display 10 in an example, according to an embodiment consistent with the principles described herein. As illustrated in FIG. 1, the multiview display 10 comprises a screen 12 to display a multiview image to be viewed. The screen 12 may be a display screen of a telephone (e.g., mobile telephone, smart phone, etc.), a tablet computer, a laptop computer, a computer monitor of a desktop computer, a camera display, or an electronic display of substantially any other device, for example. The multiview display 10 provides different views 14 of the multiview image in different view directions 16 relative to the screen 12 (i.e., multiview image comprises the different views 14). The view directions 16 are illustrated as arrows extending from the screen 12 in various different principal angular directions; the different views 14 are illustrated as shaded polygonal boxes at the termination of the arrows (i.e., depicting the view directions 16); and only four views 14 and four view directions 16 are illustrated, all by way of example and not limitation. Note that while the different views 14 are illustrated in FIG. 1 as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14.

A view direction or equivalently a light beam having a direction corresponding to a view direction of a multiview display generally has a principal angular direction or simply a ‘direction’ given by angular components {θ, ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane).

FIG. 2 illustrates a graphical representation of the angular components {θ, ϕ} of a light beam 20 having a particular principal angular direction corresponding to a view direction (e.g., view direction 16 in FIG. 1) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 2 also illustrates the light beam (or view direction) point of origin O.

Herein, the term ‘multiview’ as used in the terms ‘multiview image’ and ‘multiview display’ is defined as a plurality of views representing different perspectives or including angular disparity between views of the view plurality. In addition, herein the term ‘multiview’ may explicitly include more than two different views (i.e., a minimum of three views and generally more than three views). As such, ‘multiview display’ as employed herein may be explicitly distinguished from a stereoscopic display that includes only two different views to represent a scene or an image. Note however, while multiview images and multiview displays include more than two views, by definition herein, multiview images may be viewed (e.g., on a multiview display) as a stereoscopic pair of images by selecting only two of the multiview views to view at a time (e.g., one view per eye).

A ‘multiview pixel’ is defined herein as a set of scatterers (e.g., micro-slit scattering elements) representing ‘view’ pixels in each of a similar plurality of different views of a multiview display. In particular, a multiview pixel may have an individual pixel or set of pixels corresponding to or representing a view pixel in each of the different views of the multiview image. By definition herein therefore, a ‘view pixel’ is a pixel of a particular a view in a of a multiview display. In some embodiments, a view pixel may include one or more color sub-pixels. Moreover, the view pixels of the multiview pixel are so-called ‘directional pixels’ in that each of the view pixels is associated with a predetermined view direction of a corresponding one of the different views, by definition herein. Further, according to various examples and embodiments, the different view pixels represented by a multiview pixel may have equivalent or at least substantially similar locations or coordinates in each of the different views.

Herein, a ‘light guide’ is defined as a structure that guides light within the structure using total internal reflection. In particular, the light guide may include a core that is substantially transparent at an operational wavelength of the light guide. The term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar. In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

Herein a ‘collimator’ is defined as substantially any optical device or apparatus that is configured to collimate light. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape in one or both of two orthogonal directions that provides light collimation, according to some embodiments.

Herein, a ‘collimation factor’ is defined as a degree to which light is collimated. In particular, a collimation factor defines an angular spread of light rays within a collimated beam of light, by definition herein. For example, a collimation factor σ may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined by at one-half of a peak intensity of the collimated light beam, according to some examples.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

As used herein, the article ‘a’ is intended to have its ordinary meaning in the patent arts, namely ‘one or more’. For example, ‘a micro-slit scattering element’ means one or more micro-slit scattering element and as such, ‘the micro-slit scattering element’ means ‘micro-slit scattering element(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

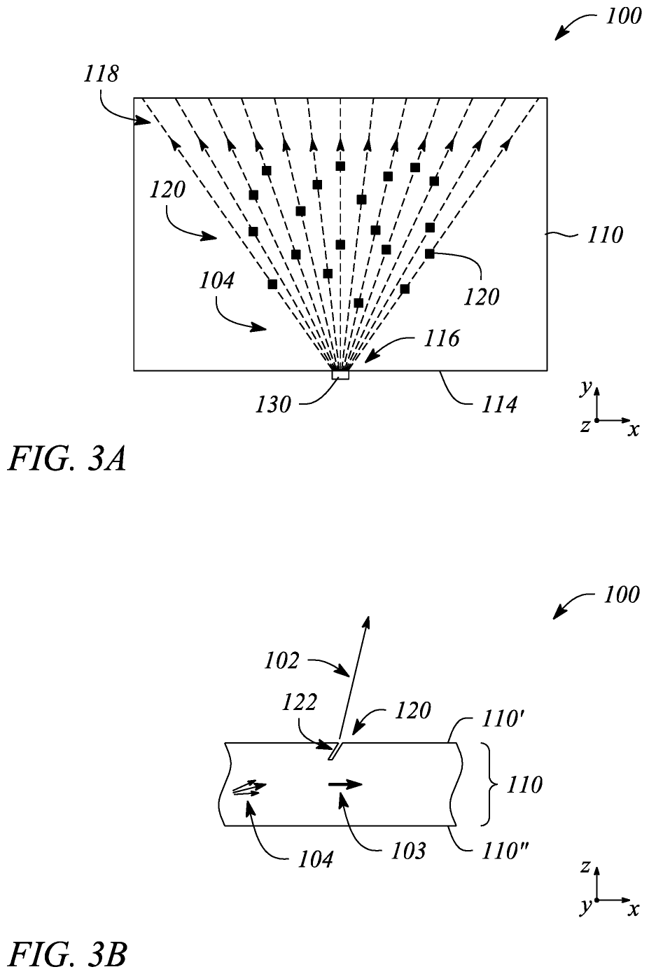

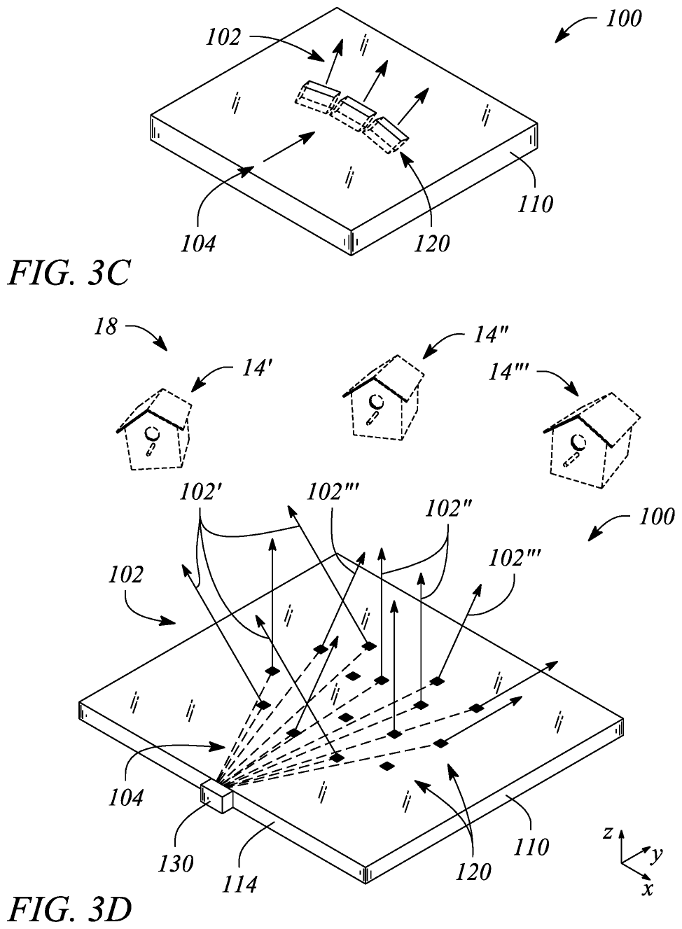

According to some embodiments of the principles described herein, a static multiview display configured to provide static or quasistatic multiview images is provided. FIG. 3A illustrates a plan view of a static multiview display 100 in an example, according to an embodiment consistent with the principles described herein. FIG. 3B illustrates cross-sectional view of a portion of a static multiview display 100 in an example, according to an embodiment consistent with the principles described herein. FIG. 3C illustrates perspective view of the portion of a static multiview display 100 illustrated in FIG. 3B in an example, according to an embodiment consistent with the principles described herein. FIG. 3D illustrates a perspective view of a static multiview display 100 in an example, according to an embodiment consistent with the principles described herein. According to some embodiments, the illustrated static multiview display 100 is configured to provide purely a static multiview image, while in others the static multiview display 100 may be configured to provide a switchable plurality of multiview images and therefore functions as (or is) a quasi-static multiview display 100. For example, the static multiview display 100 may be switchable between different fixed multiview images or equivalently between a plurality of multiview image states, as described below. Further, the static multiview display 100 is configured to provide static or quasi-static multiview images that exhibit horizontal-only parallax (HPO) views, according to some embodiments.

As illustrated, the static multiview display 100 is configured to provide a plurality of directional light beams 102, each directional light beam 102 of the plurality having an intensity and a principal angular direction. Together, the plurality of directional light beams 102 represents or encode various view pixels of a set of views of a multiview image that the static multiview display 100 is configured to provide or display. In some embodiments, the view pixels may be organized into multiview pixels to represent the various different views of the multiview images. FIG. 3B illustrates a directional light beam 102 from a side view, while FIGS. 3C and 3D illustrate a plurality of directional light beams 102 in a perspective view. Further, FIG. 3C illustrates a set of micro-slit scattering elements that represent a multiview pixel that provides a corresponding set of directional light beams 102, one directed to each of a set of different views of the static multiview image. The set of directional light beams 102 illustrated in FIG. 3C may represent directional light beams 102 directed toward different views of the multiview image, for example.

FIG. 3D illustrates an example of a plurality of directional light beams 102 that may be provided by the static multiview display 100. In particular, directional light beams 102 of the directional light beam plurality may have different directions and different intensities that represent directions and intensities of view pixels of a multiview image displayed by the static multiview display 100. For example, as illustrated in FIG. 3D the different directions may correspond to different views directions of the static multiview display 100 or equivalently views of the multiview image, according to various embodiments. For example, a first set of directional light beams 102′ having a first direction may correspond to a first view direction (or a first view) of the static multiview display 100. Similarly, a second set of directional light beams 102″ and a third set of directional light beams 102′″ may have directions corresponding to a second view direction (or a second view) and a third view direction (or third view), respectively of the static multiview display 100, and so on, as illustrated. Also illustrated in FIG. 3D are a first view 14′, a second view 14″, and a third view 14″, of a static multiview image 18 that may be provided by the static multiview display 100. The illustrated first, second, and third views 14′, 14″, 14′″, represent different perspective views of an object and collectively are the displayed static multiview image 18 (e.g., equivalent to a static version of the multiview image having views 14 illustrated in FIG. 1A). Further, the different directional light beams 102, represent view pixels of the static multiview image 18. For example, directional light beams 102′ of the first set may represent or encode view pixels of the first view 14′, directional light beams 102′ of the first set may represent or encode view pixels of the first view 14′, directional light beams 102″ of the second set may represent or encode view pixels of the second view 14″, and directional light beams 102′″ of the third set may represent or encode view pixels of the third view 14″.

As illustrated in FIGS. 3A-3D, the static multiview display 100 comprises a light guide 110. The light guide 110 is configured to guide light in a propagation direction 103 as guided light 104. Further, the guided light 104 may have or be guided according to a predetermined collimation factor σ, in various embodiments. For example, the light guide 110 may include a dielectric material configured as an optical waveguide. The dielectric material may have a first refractive index that is greater than a second refractive index of a medium surrounding the dielectric optical waveguide. The difference in refractive indices may be configured to facilitate total internal reflection of the guided light 104 according to one or more guided modes of the light guide 110.

In some embodiments, the light guide 110 may be a slab or plate optical waveguide (i.e., a plate light guide) comprising an extended, substantially planar sheet of optically transparent, dielectric material. The substantially planar sheet of dielectric material is configured to guide the guided light 104 using total internal reflection. According to various examples, the optically transparent material of the light guide 110 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, and others). In some embodiments, the light guide 110 may further include a cladding layer (not illustrated) on at least a portion of a surface (e.g., one or both of the top surface and the bottom surface) of the light guide 110. The cladding layer may be used to further facilitate total internal reflection, according to some examples. In particular, the cladding may comprise a material having an index of refraction that is greater than an index of refraction of the light guide material.

Further, according to some embodiments, the light guide 110 is configured to guide the guided light 104 according to total internal reflection at a non-zero propagation angle between a first surface 110′ (e.g., ‘front’ or ‘top’ surface or side) and a second surface 110″ (e.g., ‘back’ or ‘bottom’ surface or side) of the light guide 110. In particular, the guided light 104 propagates as a guided light beam by reflecting or ‘bouncing’ between the first surface 110′ and the second surface 110″ of the light guide 110 at the non-zero propagation angle. In some embodiments, the guided light 104 may include a plurality of guided light beams representing different colors of light. The different colors of light may be guided by the light guide 110 at respective ones of different color-specific, nonzero propagation angles. Note, the non-zero propagation angle is not illustrated in FIGS. 3A-3D for simplicity of illustration. However, a bold arrow representing the propagation direction 103 depicts a general propagation direction of the guided light 104 along the light guide length in FIG. 3A.

As defined herein, a ‘non-zero propagation angle’ is an angle relative to a surface (e.g., the first surface 110′ or the second surface 110″) of the light guide 110. Further, the non-zero propagation angle is both greater than zero and less than a critical angle of total internal reflection within the light guide 110, according to various embodiments. For example, the non-zero propagation angle of the guided light 104 may be between about ten degrees (10°) and about fifty degrees (50°) or, between about twenty degrees (20°) and about forty degrees (40°), or between about twenty-five degrees (25°) and about thirty-five (35°) degrees. For example, the non-zero propagation angle may be about thirty (30°) degrees. In other examples, the non-zero propagation angle may be about 20°, or about 25°, or about 35°. Moreover, a specific non-zero propagation angle may be chosen (e.g., arbitrarily) for a particular implementation as long as the specific non-zero propagation angle is chosen to be less than the critical angle of total internal reflection within the light guide 110.

The guided light 104 in the light guide 110 may be introduced or directed into the light guide 110 at the non-zero propagation angle (e.g., about 30-35 degrees). In some embodiments, a structure such as, but not limited to, a lens, a mirror or similar reflector (e.g., a tilted collimating reflector), a diffraction grating, and a prism (not illustrated) as well as various combinations thereof may be employed to introduce light into the light guide 110 as the guided light 104. In other examples, light may be introduced directly into the input end of the light guide 110 either without or substantially without the use of a structure (i.e., direct or ‘butt’ coupling may be employed). Once directed into the light guide 110, the guided light 104 is configured to propagate along the light guide 110 in the propagation direction 103 that is generally away from the input end.

Further, the guided light 104, having the predetermined collimation factor σ may be referred to as a ‘collimated light beam’ or ‘collimated guided light.’ Herein, a ‘collimated light’ or a ‘collimated light beam’ is generally defined as a beam of light in which rays of the light beam are substantially parallel to one another within the light beam (e.g., the guided light beam), except as allowed by the collimation factor σ. Further, rays of light that diverge or are scattered from the collimated light beam are not considered to be part of the collimated light beam, by definition herein.

As illustrated in FIGS. 3A-3D, the static multiview display 100 further comprises a plurality of micro-slit scattering elements 120 distributed across the light guide 110. In particular, micro-slit scattering elements 120 of the plurality of micro-slit scattering elements 120 are spaced apart or separated from one another one another by a finite space and represent individual, distinct elements across the light guide 110. The micro-slit scattering elements 120 of the plurality are configured to reflectively scatter out the guided light from the light guide 110 as individual ones of the directional light beams 102 of the directional light beam plurality that encode view pixels of a static multiview image (e.g., the static multiview image 18). That is, each micro-slit scattering element 120 of the micro-slit scattering element plurality is configured to reflectively scatter out or provide a different one of directional light beams 102 of the directional light beam plurality having a relative intensity and a direction that encodes a corresponding view pixel of the static multiview image, i.e., there is a single directional light beam 102 in a single principal angular direction and having a single intensity corresponding to a particular view pixel in one view of the static multiview image. As such, there is a one-to-one correspondence between a micro-split scattering element 120 and a view pixel in a view of the multiview image. According to various embodiments, the micro-slit scattering elements 120 each comprise a sloped reflective sidewall 122 having a slope angle that is tilted away from a propagation direction 103 of the guided light 104. Reflective scattering is configured to occur at or is provided by the sloped reflective sidewall 122 of the micro-slit scattering element 120.

According to some embodiments, the sloped reflective sidewall 122 of each of the micro-slit scattering elements 120 has a predetermined reflectivity characteristic configured to determine the relative intensity of the directional light beam 102 provided by the micro-slit scattering element 120. In turn, the relative intensity of the directional light beam 102 encodes an intensity or brightness of a view pixel corresponding to the micro-slit scattering element 120. For example, the predetermined reflectivity characteristic may comprise a length or depth of the sloped reflective sidewall 122. In another example, the predetermined reflectivity characteristic may comprise a surface reflectivity of the sloped reflective sidewall 122. In some examples, the predetermined reflective characteristic may comprise both the depth and the surface reflectivity. In some embodiments, the micro-slit scattering element 120 may have a predetermined rotation angle relative to a propagation angle of the guided light 104. In these embodiments, the predetermined rotation angle is configured to determine the direction of the directional light beam scattered out by the micro-slit scattering element 120 that encodes the corresponding view pixel, i.e., the direction encodes a direction of the view pixel.

In some embodiments, a micro-slit scattering element 120 of the micro-slit scattering element plurality may be disposed on or at a surface of the light guide 110. For example, the micro-slit scattering element 120 may be disposed on an emission surface (e.g., the first surface 110′) of the light guide 110, as illustrated in FIG. 3B. In this example, a micro-slit scattering element 120 of the micro-slit scattering element plurality extends into an interior of the light guide 110 and toward a second surface 110″ of the light guide 110. In another example, the micro-slit scattering element 120 may be disposed on or at the second surface 110″ opposite to the emission or first surface 110′ of the light guide 110. In this example, the micro-slit scattering element 120 of the micro-slit sub-element plurality may extend into an interior of the light guide 110 away from the second surface 110″.

In other embodiments, the micro-slit scattering element 120 may be located within the light guide 110. In particular, the micro-slit scattering element 120 may be located between and spaced away from both of the first surface 110′ and the second surface 110″ of the light guide 110, in these embodiments. For example, the micro-slit scattering element 120 may be provided on a surface of the light guide 110 and then covered by layer of light guide material to effectively bury the micro-slit scattering element 120 in an interior of the light guide 110.

In yet another embodiment, the micro-slit scattering element 120 may be disposed in an optical material layer located on a surface of the light guide 110. In some these embodiments, a surface of the optical material layer may be the emission surface and a micro-slit scattering element 120 of the micro-slit scattering element plurality may extend away from the emission surface and toward the light guide surface. The optical material layer located on the surface of the light guide 110 may be index-matched to a refractive index to a material of the light guide 110 to reduce or substantially minimize reflection of light at an interface between the light guide 110 and the material layer, in some embodiments. In other embodiments, the material may have a refractive index that is higher than a refractive index of the light guide material. Such a higher index material layer may be used to improve brightness of the emitted light comprising the directional light beams 102, for example.

According to some embodiments, a micro-slit scattering element 120 of the micro-slit scattering element plurality may comprise a plurality of micro-slit sub-elements 124. In particular, the guided light portion may be reflectively scattered out collectively by the plurality of micro-slit sub-elements 124 of the micro-slit scattering element 120 using reflection or reflective scattering, according to various embodiments. According to various embodiments, each micro-slit sub-element 124 of the micro-slit sub-element plurality may comprise a sloped reflective sidewall having a slope angle tilted away from the propagation direction of the guided light, by definition herein. In some embodiments, the sloped reflective sidewall of the micro-slit sub-element 124 may be substantially similar to the sloped reflective sidewall 122 of the micro-slit scattering element 120. The is, the sloped reflective sidewall 122 of the micro-slit scattering element 120 may comprise one or more sloped reflective sidewalls of the micro-slit sub-elements 124. Further, the presence of the plurality of micro-slit sub-elements 124 within one or more of the micro-slit scattering elements 120 may facilitate granular control of reflective scattering properties of the emitted light and, by extension, of the directional light beams 102 of the emitted light.

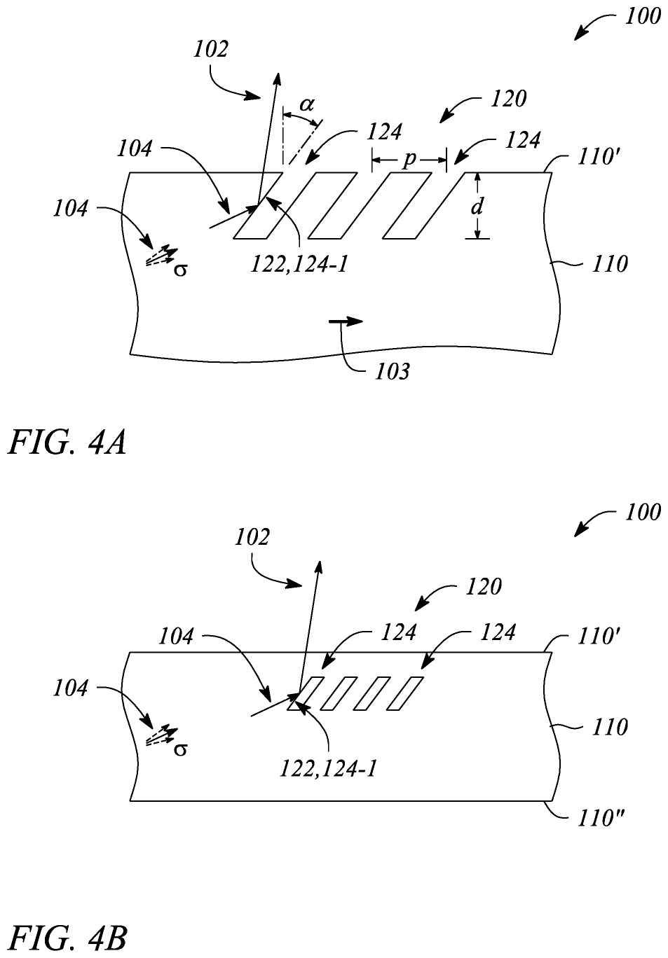

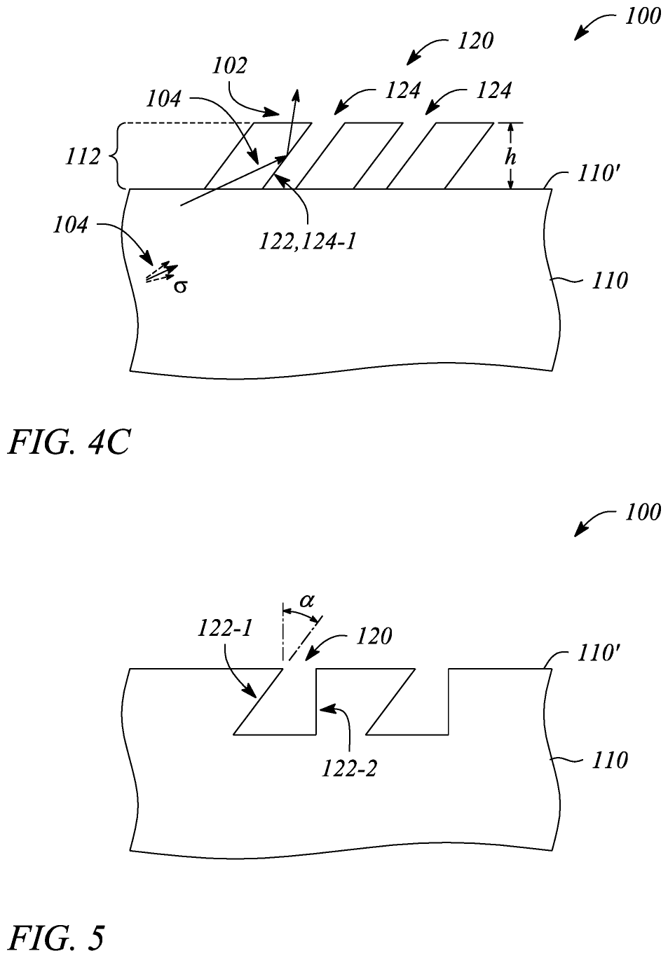

FIG. 4A illustrates a cross-sectional view of a portion of a static multiview display 100 in an example, according to an embodiment of the principles described herein. As illustrated in FIG. 4A, the static multiview display 100 comprises the light guide 110 with a micro-slit scattering element 120 disposed on the first surface 110′ of the light guide 110. The micro-slit scattering element 120 illustrated in FIG. 4A extends into an interior of the light guide 110 and comprises a plurality of micro-slit sub-elements 124. As illustrated, guided light 104 is reflected by the sloped reflective sidewall 122 of the micro-slit scattering element 120 comprising a sloped reflective sidewall 124-1 of a micro-slit sub-element 124 and exits the emission surface of the light guide 110 (e.g., the first surface 110′) as the emitted light comprising a directional light beam 102. In particular, the guided light 104 may be reflected by one or more of the sloped reflective sidewalls 124-1 of the micro-slit sub-elements 124 of the micro-slit scattering element 120, as illustrated. Further, as illustrated in FIG. 4A, the sloped reflective sidewall 122 of the micro-slit scattering element 120 or equivalently the sloped reflective sidewall 124-1 of the micro-slit sub-element 124 has a slope angle α that is tilted away from the propagation direction 103 of the guided light 104. In some embodiments, a depth d of the micro-slit scattering element 120 comprising micro-slit sub-element(s) 124 may be about equal to a pitch p of (or spacing) between adjacent micro-slit sub-elements 124 within the micro-slit scattering element 120.

FIG. 4B illustrates a cross-sectional view of a portion of a static multiview display 100 in an example, according to another embodiment of the principles described herein. As illustrated in FIG. 4B, the static multiview display 100 comprises the light guide 110 and the micro-slit scattering element 120 comprising a plurality of micro-slit sub-elements 124. However, in FIG. 4B the micro-slit scattering element 120 is located within the light guide 110 between the first and second surfaces 110′, 110″. As in FIG. 4A, guided light 104 is illustrated in FIG. 4B as being reflected by the sloped reflective sidewall 122 of the micro-slit scattering element 120 (e.g., a sloped reflective sidewall 124-1 of a first micro-slit sub-element 124) and exiting the emission surface of the light guide 110 (first surface 110′) as the emitted light comprising a directional light beam 102.

FIG. 4C illustrates a cross-sectional view of a portion of a static multiview display 100 in an example, according to another embodiment of the principles described herein. As illustrated, the static multiview display 100 comprises the light guide 110 having an optical material layer 112 disposed on the first surface 110′ of the light guide 110. The micro-slit scattering element 120 illustrated in FIG. 4C is located in the optical material layer 112. Further, as illustrated, the micro-slit scattering element 120 comprises a plurality of micro-slit sub-elements 124 with respective sloped reflective sidewalls 122, 124-1. In FIG. 4C, the micro-slit sub-elements 124 of the micro-slit sub-element plurality and also the micro-slit scattering element 120 extend away from an emission surface comprising a surface of the optical material layer 112 and toward the first surface 110′ of the light guide 110. Further, a depth of the micro-slit sub-elements 124, or equivalently of the micro-slit scattering element 120, may be comparable to a thickness or height h of the optical material layer 112, e.g., as illustrated. In FIG. 4C, guided light 104 is illustrated passing from the light guide 110 into the optical material layer 112 and then subsequently being reflected by the sloped reflective sidewall 122 of a first of the micro-slit sub-elements 124 to provide the emitted light comprising a directional light beam 102.

Note that while FIGS. 4A-4C illustrate a micro-slit scattering element 120 comprising a plurality of micro-slit sub-elements 124, each of these figures may equally illustrate a micro-slit scattering element 120 by itself by merely considering one of the illustrated micro-slit sub-elements 124. Also note that while each of the micro-slit sub-elements 124 of the micro-slit scattering element 120 illustrated in FIGS. 4A-4C have a similar in size and shape, in some embodiments (not illustrated) micro-slit sub-elements 124 of the micro-slit sub-element plurality or equivalently micro-slit scattering elements 120 of the micro-slit scattering element plurality may differ from one another within the respective pluralities. For example, the micro-slit sub-elements 124 may have one or more of different sizes, different cross-sectional profiles, and even different orientations (e.g., a rotation relative to the guided light propagation directions) within and across the micro-slit scattering element 120. Similarly, the micro-slit scattering elements 120 may have one or more of different sizes, different cross-sectional profiles, and even different orientations (e.g., a rotation relative to the guided light propagation directions) within and across the micro-slit scattering element plurality. In particular, at least two micro-slit sub-elements 124 of the micro-slit sub-element plurality or two micro-slit scattering elements 120 of the micro-slit scattering element plurality may have different reflective scattering profiles from one another, according to some embodiments.

According to some embodiments, the sloped reflective sidewall 122 of the micro-slit scattering element 120 or equivalently the sloped reflective sidewall 124-1 of the micro-slit sub-element 124 of the micro-slit sub-element plurality is configured to reflectively scatter out a portion of the guided light 104 according to total internal reflection (i.e., due to a difference between a refractive index of materials on either side of the sloped reflective sidewall 122). That is, the guided light 104 having an incident angle of less than a critical angle at the sloped reflective sidewall 122 is reflected by the sloped reflective sidewall 122 to become the directional light beam 102 of the emitted light.

In some embodiments, the slope angle α of the sloped reflective sidewall 122, 124-1 is between zero degrees (0°) and about forty-five degrees (45°) relative to a surface normal of the emission surface of the light guide 110 (or equivalently of the static multiview display 100). In some embodiments, the slope angle α of the sloped reflective sidewall 122, 124-1 is between 10 degrees (10°) and about forty degrees (40°). For example, the slope angle α of the sloped reflective sidewall 122, 124-1 may be about twenty degrees (20°), or about thirty degrees (30°), or about thirty-five degrees (35°), relative to a surface normal of the emission surface of the light guide 110.

According to various embodiments, the slope angle α is selected in conjunction with the non-zero propagation angle of the guided light 104 to provide a target angle of the directional light beam 102 of the emitted light. Further, the selected slope angle α may be configured to preferentially scatter light in a direction of the emission surface of the light guide 110 (e.g., the first surface 110′) and away from a surface of the light guide 110 opposite to the emission surface (e.g., the second surface 110″). That is, the sloped reflective sidewall 122, 124-1 may provide little or substantially no scattering of the guided light 104 in a direction away from the emission surface, in some embodiments.

In some embodiments, the sloped reflective sidewall 122, 124-1 may comprise a reflective material configured to reflectively scatter out a portion of the guided light 104. For example, the reflective material may be a layer of a reflective metal (e.g., aluminum, nickel, gold, silver, chrome, copper, etc.) or a reflective metal-polymer (e.g., polymer-aluminum) that coated on the sloped reflective sidewall 122, 124-1. In another example, an interior of the micro-slit scattering element 120 or of the micro-slit sub-element 124 may be filled or substantially filled with the reflective material. The reflective material that fills the micro-slit scattering element 120 or micro-slit sub-element 124 may provide reflective scattering of the guided light portion at the sloped reflective sidewall, in some embodiments.

In some embodiments (e.g., as illustrated in FIGS. 4A-4C), a first sidewall of a micro-slit scattering element 120 or of a micro-slit sub-element 124 of the micro-slit sub-element plurality may have a slope angle that is substantially similar to a slope angle of a second sidewall of the micro-slit scattering element 120 or micro-slit sub-element 124. That is, opposing sidewalls may be substantially parallel to one another. In other embodiments, the first sidewall may have a slope angle that differs from a slope angle of a second sidewall, the first sidewall being the sloped reflective sidewall 122.

FIG. 5 illustrates a cross-sectional view of a portion of a static multiview display 100 including a micro-slit scattering element 120 in an example, according to an embodiment consistent with the principles described herein. As illustrated, the micro-slit scattering element 120 is depicted at a first surface 110′ of the light guide 110 with the first sidewall 122-1 of the micro-slit scattering element 120 representing the sloped reflective sidewall having a slope angle α. Further, a second sidewall 122-2 of the micro-slit scattering element 120 has a different slope angle from the slope angle α of the first sidewall 122-1, as illustrated. In particular, the second sidewall 122-2 illustrated in FIG. 5 has a slope angle of about zero degrees (0°), i.e., the slope angle of the second sidewall 122-2 is substantially parallel to a surface normal of the first surface 110′ of the light guide 110, as illustrated.

In some embodiments, a micro-slit scattering element of the micro-slit scattering element plurality may have a curved shape in a direction that is orthogonal to the guided light propagation direction 103. In particular, the curved shape may be in a direction that is orthogonal to the propagation direction 103 and also in a plane parallel to a surface of the light guide 110. According to some embodiments, the curved shape may be configured to control emission pattern of scattered light in a plane orthogonal to the guided light propagation direction.

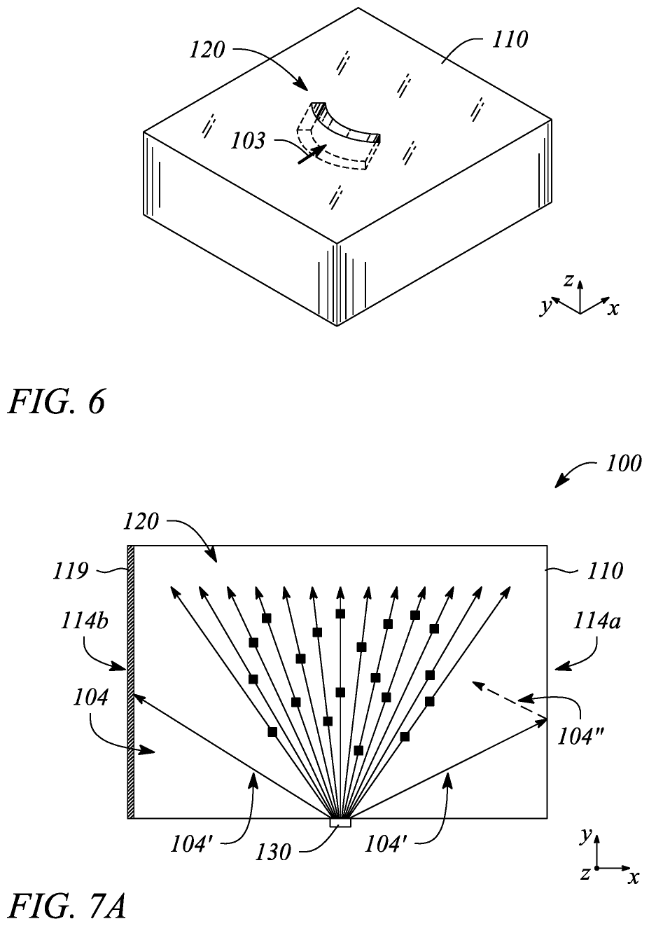

FIG. 6 illustrates a perspective view of a curved micro-slit scattering element 120 in an example, according to an embodiment consistent with the principles described herein. As illustrated, the curved micro-slit scattering element 120 is located in the light guide 110 and has a curved shape that is convex relative to the propagation direction 103 of the guided light. The convex curved shape of the micro-slit scattering element 120 may be used to increase a spread the reflectively scattered light in x-y direction, as illustrated. In another example (not illustrated), the curved shape of the micro-slit scattering element 120 may be concave relative to the propagation direction 103 to decrease a spread of the reflectively scattered light, for example. Further, a radius of curvature of the curved shape may be preferentially selected to control an amount of spread of the reflectively scattered light, in some embodiments. The curved shape may equally be applied to micro-slit sub-elements (not illustrated).

Referring again to FIGS. 3A-3D, according to some embodiments the static multiview display may further comprise a light source 130 at an input location on the light guide 110. As illustrated, the light source 130 may be configured to provide within the light guide 110 the guided light 104 comprising a plurality of guided light beams (illustrated as dashed lines in FIGS. 3A and 3D) having different radial directions 118 from one another, i.e., the guided light 104 has a ‘fan-shape’ pattern of propagation in the light guide 110. In these embodiments, different micro-slit scattering elements 120 of the micro-slit scattering element plurality may be aligned with and configured to scatter out guided light 104 from different guided light beams of the guided light beam plurality having the different radial directions 118 within the light guide 110. For example, the light source 130 may be located adjacent to an edge or side 114 of the light guide 110, as illustrated.

In particular, as illustrated in FIGS. 3A and 3D, light emitted by the light source 130 may be configured enter the light guide 110 and to propagate as the plurality of guided light beams in a radial pattern away from the input location 116 and across or along a length of the light guide 110. Further, the individual guided light beams of the guided light beam plurality have different radial directions from one another by virtue of the radial pattern of propagation away from the input location 116. For example, the light source 130 may be butt-coupled to the side 114. The light source 130 being butt-coupled may facilitate introduction of light in a fan-shape pattern to provide the different radial directions of the individual guided light beams of the guided light 104, for example. According to some embodiments, the light source 130 may be or at least approximate a ‘point’ source of light at the input location 116 such that the individual guided light beams of the guided light 104 propagate along the different radial directions 118 (i.e., as the plurality of guided light beams).

In some embodiments, the input location 116 of the light source 130 is on the side 114 of the light guide 110 near or about at a center or a middle of the side 114. In particular, in FIGS. 3A and 3D, the light source 130 is illustrated at an input location 116 that is approximately centered on (e.g., at a middle of) the side 114 (i.e., the ‘input side’) of the light guide 110. Alternatively (not illustrated), the input location 116 may be away from the middle or center of the side 114 of the light guide 110. For example, the input location 116 may be at a corner of the light guide 110. For example, the light guide 110 may have a rectangular shape (e.g., as illustrated) and the input location 116 of the light source 130 may be at a corner of the rectangular-shaped light guide 110 (e.g., a corner of the input side 114).

In various embodiments, the light source 130 may comprise substantially any source of light (e.g., optical emitter) including, but not limited to, one or more light emitting diodes (LEDs) or a laser (e.g., laser diode). In some embodiments, the light source 130 may comprise an optical emitter configured produce a substantially monochromatic light having a narrowband spectrum denoted by a particular color. In particular, the color of the monochromatic light may be a primary color of a particular color space or color model (e.g., an RGB color model). In other examples, the light source 130 may be a substantially broadband light source configured to provide substantially broadband or polychromatic light. For example, the light source 130 may provide white light. In some embodiments, the light source 130 may comprise a plurality of different optical emitters configured to provide different colors of light. The different optical emitters may be configured to provide light having different, color-specific, non-zero propagation angles of the guided light corresponding to each of the different colors of light.

In some embodiments, the guided light beams of the guided light 104 produced by coupling light from the light source 130 into the light guide 110 may be uncollimated or at least substantially uncollimated. In other embodiments, the guided light beams may be collimated in a vertical direction (i.e., the guided light 104 may be collimated in a direction perpendicular to the first and second surfaces 110′, 110″ of the light guide 110). As such, in some embodiments, the static multiview display 100 may include a ‘vertical’ collimator (not illustrated) between the light source 130 and the light guide 110. Alternatively, the light source 130 may further comprise a vertical collimator. The vertical collimator is configured to provide guided light beams within the light guide 110 that are collimated in the vertical direction. In particular, the vertical collimator is configured to receive substantially uncollimated light from one or more of the optical emitters of the light source 130 and to convert the substantially uncollimated light into vertically collimated light. That is, the vertical collimator is configured to provide collimation in a plane (e.g., a ‘vertical’ plane) that is substantially perpendicular to the propagation direction of the guided light 104, by definition. In particular, the vertical collimation may provide collimated guided light beams having a relatively narrow angular spread in a plane perpendicular to a surface of the light guide 110 (e.g., the first or second surface 110′, 110″). According to various embodiments, the vertical collimator may comprise any of a variety of collimators including, but not limited to a lens, a reflector or mirror (e.g., tilted collimating reflector), or a diffraction grating (e.g., a diffraction grating-based barrel collimator) configured to collimate the light, e.g., from the light source 130.

Further, in some embodiments, the collimator may provide vertical collimated light one or both of having the non-zero propagation angle and being collimated according to a predetermined collimation factor. Moreover, when optical emitters of different colors are employed, the collimator may be configured to provide the collimated light having one or both of different, color-specific, non-zero propagation angles and having different color-specific collimation factors. The collimator is further configured to communicate the collimated light to the light guide 110 to propagate as the guided light beams, in some embodiments.

Use of collimated or uncollimated light may impact the multiview image that may be provided by the static multiview display 100, in some embodiments. For example, if the guided light beams of the guided light 104 are collimated within the light guide 110, the emitted directional light beams 102 may have a relatively narrow or confined angular spread in at least two orthogonal directions. Thus, the static multiview display 100 may provide a multiview image having a plurality of different views in an array having two different directions (e.g., an x-direction and a y-direction). However, if the guided light beams of the guided light 104 are substantially uncollimated, the multiview image may provide view parallax, but may not provide a full, two-dimensional array of different views. In particular, if the guided light beams are uncollimated (e.g., along the z-axis), the multiview image may provide different multiview images exhibiting ‘parallax 3D’ or ‘full-parallax’ when rotated about the y-axis (e.g., as illustrated in FIG. 1A). On the other hand, if the static multiview display 100 is rotated around the x-axis, for example, the multiview image and views thereof may remain substantially unchanged or the same because the directional light beams 102 of the directional light beam plurality have a broad angular range within the y-z plane. Thus, the multiview image provided may be ‘horizontal-parallax-only’ (HPO) providing an array of views in only one direction and not two.

In some embodiments, provision may be made to mitigate, and in some instances even substantially eliminate, various sources of spurious reflection of guided light 104 within the static multiview display 100, especially when those spurious reflection sources may result in emission of unintended direction light beams and, in turn, the production of unintended images by static multiview display 100. Examples of various potential spurious reflection sources include, but not limited to, sidewalls of the light guide 110 that may produce a secondary reflection of the guided light 104. Reflection from various spurious reflection sources within the static multiview display 100 may be mitigated by any of a number of techniques including, but not limited to absorption and controlled redirection of the spurious reflection.

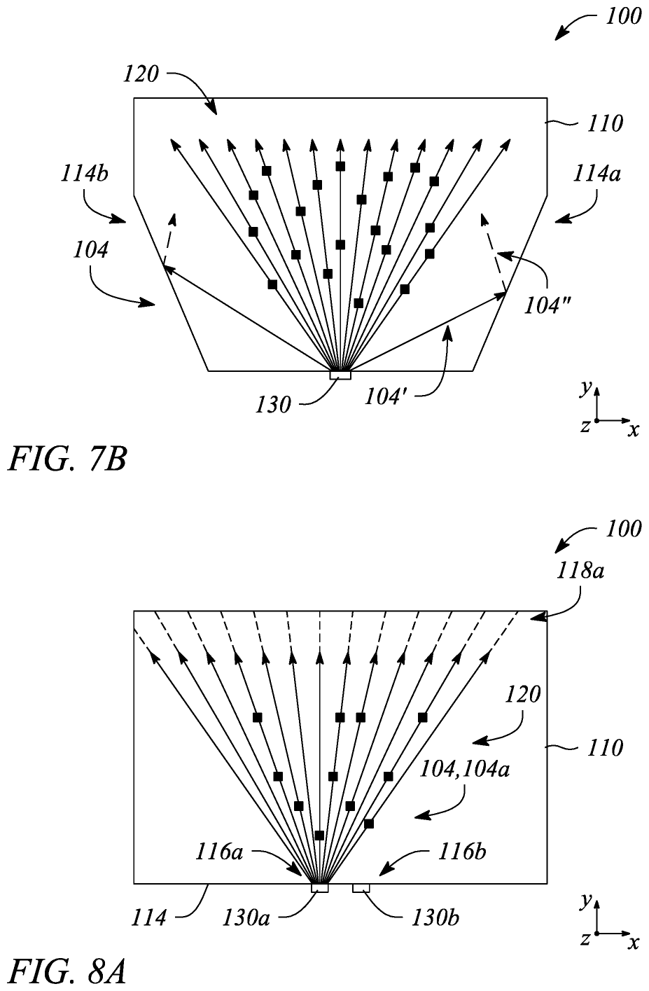

FIG. 7A illustrates a plan view of a static multiview display 100 including spurious reflection mitigation in an example, according to an embodiment consistent with the principles described herein. FIG. 7B illustrates a plan view of a static multiview display 100 including spurious reflection mitigation in an example, according to another embodiment consistent with the principles described herein. In particular, FIGS. 7A and 7B illustrate the static multiview display 100 comprising the light guide 110, the plurality of micro-slit scattering elements 120, and the light source 130. Also illustrated is the plurality of guided light beams of the guided light 104 with at least one guided light beam 104′ of the plurality being incident on a sidewall 114a, 114b of the light guide 110. A potential spurious reflection of the guided light beam 104′ by the sidewall 114a is illustrated by a dashed arrow representing a reflected guided light beam 104″.

In FIG. 7A, the static multiview display 100 further comprises an absorbing layer 119 at the sidewall 114b of the light guide 110. The absorbing layer 119 is configured to absorb incident light from the guided light beams, e.g., guided light beam 104′. The absorbing layer may comprise substantially any optical absorber including, but not limited to, black paint applied to the sidewall 114b for example. As illustrated in 7A, the absorbing layer 119 is applied to the sidewall 114b, while the sidewall 114a lacks the absorbing layer 119, by way of example and not limitation. The absorbing layer 119 intercepts and absorbs the incident guided light beam 104′ effectively preventing or mitigating the production of the potential spurious reflection from the sidewall 114b. On the other hand, guided light beam 104′ incident on the sidewall 114a reflects resulting in the production of the reflected guided light beam 104″, illustrated by way of example and not limitation.

FIG. 7B illustrates spurious reflection mitigation using controlled reflection angle. In particular, the light guide 110 of the static multiview display 100 illustrated in FIG. 7B comprises sidewalls 114a, 114b that are slanted (i.e., slanted sidewalls). The slanted sidewalls have a slant angle configured to intercept an incident guided light beam (e.g., guided light beam 104′) and preferentially direct the reflected guided light beam 104″ substantially away from the micro-slit scattering elements 120. As such, the reflected guided light beam 104″ is not scattered out of the light guide 110 as an unintended directional light beam. The slant angle of the sidewalls 114a, 114b may be in the x-y plane, as illustrated. In other examples (not illustrated), the slant angle of the sidewalls 114a, 114b may be in another plane, e.g., the x-z plane to direct the reflected guided light beam 104″ out a top or bottom edge of the light guide 110, e.g., the reflective guide light beam 104″ is illustrated as being directed out the top edge of the light guide 110 in FIG. 7B by way of example and not limitation. Note that FIG. 7B illustrates sidewalls 114a, 114b that include a slant along only a portion of thereof, by way of example and not limitation.

According to some embodiment, the static multiview display 100 may comprise a plurality of light sources 130 that are laterally offset from one another. The lateral offset of light sources 130 of the light source plurality may provide a difference in the radial directions of various guided light beams of the guided light 104 at or between individual micro-slit scattering elements 120. The difference, in turn, may facilitate providing animation of a displayed multiview image, according to some embodiments. Thus, the static multiview display 100 may be a ‘quasi-static’ multiview display, in some embodiments.

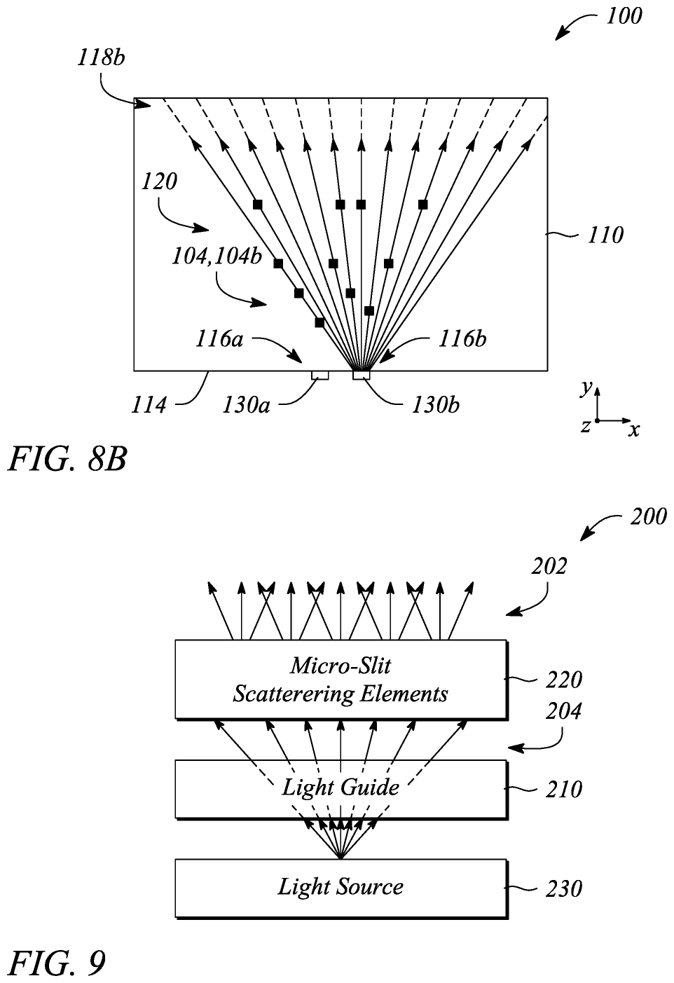

FIG. 8A illustrates a plan view of a static multiview display 100 in an example, according to an embodiment consistent with the principles described herein. FIG. 8B illustrates a plan view of the static multiview display 100 of FIG. 8A in another example, according to an embodiment consistent with the principles described herein. The static multiview display 100 illustrated in FIGS. 8A and 8B comprises a light guide 110 with a plurality of micro-slit scattering elements 120. In addition, the static multiview display 100 further comprises a plurality of light sources 130 that are laterally offset from each other and configured to separately provide guided light beams of the guided light 104 having different radial directions 118 from one another, as illustrated.

In particular, FIGS. 8A and 8B illustrate a first light source 130a at a first input location 116a and a second light source 130b at a second input location 116b on the side 114 (input side) of the light guide 110. The first and second input locations 116a, 116b are laterally offset or shifted from one another along the side 114 (i.e., in an x-direction) to provide the lateral offset of respective first and second light sources 130a, 130b. Additionally, each of the first and second light sources 130a, 130b of the plurality of light sources 130 provide a different plurality of guided light beams 104a, 104b of the guided light 104 having respective different radial directions from one another. For example, the first light source 130a may provide a first plurality of guided light beams 104a having a first set of different radial directions 118a and the second light source 130b may provide a second plurality of guided light beams 104b having a second set of different radial directions 118b, as illustrated in FIGS. 8A and 8B, respectively. Further, the first and second pluralities of guided light beams 104a, 104b generally have sets of different radial directions 118a, 118b that also differ from one another as sets by virtue of the lateral offset of the first and second light sources 130a, 130b, as illustrated.

Therefore, the plurality of micro-slit scattering elements 120 emit directional light beams representing different multiview images that are shifted in a view space from one another (e.g., angularly shifted in view space). Thus, by switching between the first and second light sources 130a, 130b, the static multiview display 100 may provide ‘animation’ of the multiview images, such as a time-sequenced animation. In particular, by sequentially illuminating the first and second light sources 130a, 130b during different sequential time intervals or periods, static multiview display 100 may be configured to shift an apparent location of the multiview image during the different time periods, for example. This shift in apparent location provided by the animation may represent an example of operating the static multiview display 100 as a quasi-static multiview display to provide a plurality of multiview image states, according to some embodiments.

FIG. 9 illustrates a block diagram of a static multiview display 200 in an example, according to another embodiment consistent with the principles described herein. According to various embodiments, the static multiview display 200 is configured to display a static multiview image having different views in different view directions. In particular, directional light beams 202 of light emitted by the static multiview display 200 may be used to display the multiview image and may correspond to pixels of the different views (i.e., view pixels).

As illustrated in FIG. 9, the static multiview display 200 comprises a light guide 210. The light guide 210 is configured to guide light in a propagation direction as a plurality of guided light beams 204. According to various embodiments, guided light beams 204 of the guided light beam plurality have or are guided in the fan-shaped pattern. In particular, within the fan-shaped pattern, guided light beams 204 of the guided light beam plurality have different radial directions from one another and appear to emanate from a common point of origin, according to some embodiments. The guided light beams may be guided within the light guide according to total internal reflection, in various embodiments. For example, the light guide 210 may be a plate light guide configured to guide light from a light-input edge thereof as a guided light beam 204. In some embodiments, the light guide 210 of the static multiview display 200 may be substantially similar to the light guide 110 described above with respect to the static multiview display 100.

The static multiview display 200 illustrated in FIG. 9 further comprises a plurality of micro-slit scattering elements 220. According to various embodiments, micro-slit scattering elements 220 of the micro-slit scattering element plurality are spaced apart from one another across the light guide 110. Micro-slit scattering elements 220 of the micro-slit scattering element plurality are configured to emit directional light beams 202 representing view pixels a static multiview image. Each micro-slit scattering element 220 of the micro-slit scattering element plurality comprises a sloped reflective sidewall and is configured to emit or provide from a portion of a guided light beam 204 of the guided light beam plurality a directional light beam 202 having an intensity and a direction corresponding to a relative intensity and a view direction of a view pixel of the static multiview image. In particular, the directional light beam 202 provided by each of the micro-slit scattering element 220 encodes a different one of the view pixels of the static multiview image. According to various embodiments, the directional light beams 202 emitted or provided by the reflective scattering from the sloped reflective sidewall have different principal angular directions from one another. The different principal angular directions of the directional light beams correspond to different view directions of respective ones of the different view pixels of the static multiview image, according to various embodiments. In some embodiments, the micro-slit scattering elements 220 the static multiview display 200 may be substantially similar to the micro-slit scattering elements 120, respectively, of the above-described static multiview display 100. For example, the micro-slit scattering elements 220 may comprise a plurality of micro-slit sub-elements that, in turn, are substantially similar to the micro-slit sub-elements 124, described above. According to various embodiments, each micro-slit scattering element 220 and similarly each micro-slit sub-element comprises a sloped reflective sidewall having a slope angle tilted away from the propagation direction of the guided light.

In some embodiments, the sloped reflective sidewall of each of the micro-slit scattering elements 220 has a predetermined reflectivity characteristic determined by one or both of a depth of the sloped reflective sidewall and a surface reflectivity of a surface of the sloped reflective sidewall that is configured to determine the relative intensity of a directional light beam corresponding to the micro-slit scattering element. In some embodiments, each of the micro-slit scattering elements 220 of the micro-slit scattering element plurality may have a predetermined rotation angle relative to the radial direction of a guided light beam 204 corresponding to the micro-slit scattering element 220. The predetermined rotation angle may be configured to determine the direction of the directional light beam 202, according to some embodiments.

In some embodiments, a micro-slit scattering element 220 of the micro-slit scattering element plurality is one of disposed on an emission surface of the light guide (or equivalently of the static multiview display 200) and disposed below the emission surface. In these embodiments, the micro-slit scattering element 220 extends into an interior of the light guide away from the emission surface. In some embodiments, a micro-slit scattering element 220 of the micro-slit scattering element plurality is disposed in a light guide material layer located on a surface of the light guide. In these embodiments, a surface of the light guide material layer may be an emission surface of the static multiview display 200 and the micro-slit scattering element 220 may extend away from the emission surface and toward the surface of the light guide 210.

As illustrated in FIG. 9, the static multiview display 200 further comprises a light source 230. The light source 230 is configured to provide within the light guide 210 the plurality of guided light beams 204 having the different radial directions from one another. In some embodiments, the light source 230 may be substantially similar to the light source 130 of the above-described static multiview display 100. For example, the light source 230 may be butt-coupled to an edge of the light guide 210 and may approximate a point source of light.

In some embodiments, the guided light may be collimated (e.g., in a vertical direction) according to a predetermined collimation factor. In some embodiments, an emission pattern of the emitted light comprising the directional light beams 202 is a function of the predetermined collimation factor of the guided light. For example, predetermined collimation factor may be substantially similar to the predetermined collimation factor σ, described above with respect to the static multiview display 100.

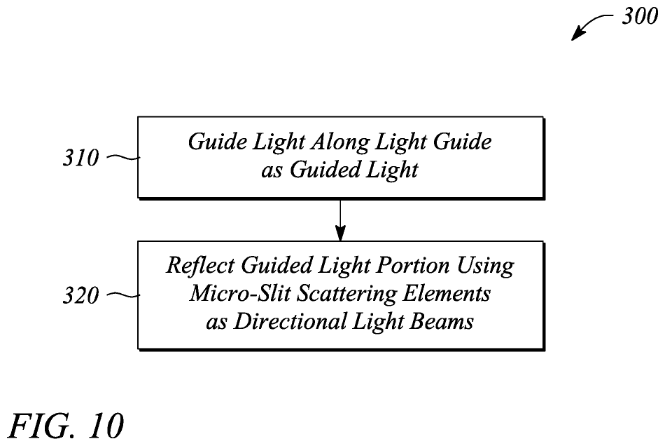

In accordance with some embodiments of the principles described herein, a method of static multiview display operation is provided. FIG. 10 illustrates a flow chart of a method 300 of static multiview display operation in an example, according to an embodiment consistent with the principles described herein. As illustrated in FIG. 10, the method 300 of static multiview display operation comprises guiding 310 light in a propagation direction along a length of a light guide as guided light. In some embodiments, the light may be guided 310 at a non-zero propagation angle. Further, the guided light may be collimated. In particular, the guided light may be collimated according to a predetermined collimation factor. In some embodiments, guiding 310 light may provide guided light having a fan-shaped pattern with guided light beams with different radial directions from one another. According to some embodiments, the light guide may be substantially similar to the light guide 110 described above with respect to the static multiview display 100. In particular, the light may be guided according to total internal reflection within the light guide, according to various embodiments. Similarly, the predetermined collimation factor and non-zero propagation angle may be substantially similar to the predetermined collimation factor σ and non-zero propagation angle described above with respect to the light guide 110 of the static multiview display 100.

As illustrated in FIG. 10, the method 300 of static multiview display operation further comprises reflecting 320 a portion of the guided light out of the light guide as a corresponding plurality of directional light beams using a plurality of micro-slit elements. According to various embodiments, the directional light beams encode view pixels of a static multiview image. In addition, each micro-slit scattering element of the micro-slit scattering element plurality provides a different one of directional light beams having a relative intensity and a direction of a corresponding view pixel of a static multiview image. In particular, there is a one-to-one correspondence between each of a micro-slit scattering element, a scattered out directional light beam provided by the micro-slit scattering element, and a view pixel of the static multiview image encoded by the directional light beam, according to various embodiments.

In some embodiments, the micro-slit scattering elements of the micro-slit scattering element plurality are substantially similar to the micro-slit scattering elements 120 described above with respect to the static multiview display 100. In particular, micro-slit scattering elements each comprise a sloped reflective sidewall having a slope angle that is tilted away from the propagation direction of the guided light.

In some embodiments, the sloped reflective sidewall reflectively scatters light according to total internal reflection to reflect the portion of the guided out of the light guide to provide the directional light beam. In other embodiments, a micro-slit scattering element of the micro-slit scattering element array further comprises a reflective material adjacent to and coating the sloped reflective sidewall of the plurality of micro-slit sub-elements.

In some embodiments, the slope angle of the sloped reflective sidewall may be between about zero degrees (0°) and about forty-five degrees (45°) relative to a surface normal of an emission surface of the light guide, in some embodiments. In some embodiments, the slope angle may be chosen in conjunction with a non-zero propagation angle of the guided light to preferentially scatter light in a direction of the emission surface of the light guide and away from a surface of the light guide opposite to the emission surface.

In some embodiments (not illustrated), the method 300 of static multiview display operation further comprises providing light to be guided by the light guide using a light source, the light source providing within the light guide the guided light comprising a plurality of guided light beams having different radial directions from one another. In these embodiments, different micro-slit scattering elements of the micro-slit scattering element plurality are aligned with and reflect out guided light from different guided light beams of the guided light beam plurality having the different radial directions within the light guide. In some embodiments, the light source may be substantially similar to the light source 130 of the static multiview display 100, described above.

Thus, there have been described examples and embodiments of a static multiview display and a method of static multiview display operation that employ micro-slit elements having a sloped reflective sidewall to provide emitted light including directional light beams having directions and intensities corresponding to different view pixels of a multiview image. It should be understood that the above-described examples are merely illustrative of some of the many specific examples that represent the principles described herein. Clearly, those skilled in the art can readily devise numerous other arrangements without departing from the scope as defined by the following claims.

1-23. (canceled)

24. A static multiview display comprising:
a light guide configured to guide light as guided light; and
a plurality of micro-slit scattering elements distributed across the light guide and configured to reflectively scatter out the guided light from the light guide as a corresponding plurality of directional light beams that encode view pixels of a static multiview image,
each micro-slit scattering element of the micro-slit scattering element plurality being configured to reflectively scatter out a different one of directional light beams having a relative intensity and a direction that encode a corresponding view pixel of the static multiview image,
wherein the micro-slit scattering elements each comprise a sloped reflective sidewall having a slope angle that is tilted away from a propagation direction of the guided light.

25. The static multiview display of claim 24, wherein the sloped reflective sidewall of each of the micro-slit scattering element has a predetermined reflectivity characteristic configured to determine the relative intensity of the directional light beam that encodes the corresponding view pixel, the predetermined reflectivity characteristic comprising at least one of a depth of the sloped reflective sidewall or a surface reflectivity of the sloped reflective sidewall.

26. The static multiview display of claim 24, wherein the micro-slit scattering element has a predetermined rotation angle relative to a propagation angle of the guided light, the predetermined rotation angle being configured to determine the direction of the directional light beam scattered out by the micro-slit scattering element that encodes the corresponding view pixel.

27. The static multiview display of claim 24, wherein a micro-slit scattering element of the micro-slit scattering element plurality comprises a plurality of micro-slit sub-elements, each micro-slit sub-element having the sloped reflective sidewall.

28. The static multiview display of claim 24, wherein a micro-slit scattering element of the micro-slit scattering element plurality is disposed on an emission surface of the light guide, the micro-slit scattering element extending into an interior of the light guide away from the emission surface.

29. The static multiview display of claim 24, wherein:
a micro-slit scattering element of the micro-slit scattering element plurality is disposed in a light guide material layer located on a surface of the light guide, a surface of the light guide material layer being an emission surface and the micro-slit scattering element extending away from the emission surface and toward the light guide surface; and
a refractive index of the light guide material layer located on the surface of the light guide is greater than a refractive index of a material of the light guide.

30. The static multiview display of claim 24, wherein the sloped reflective sidewall of the micro-slit scattering element of the micro-slit scattering element plurality comprises a reflective material configured to reflectively scatter out the guided light.

31. The static multiview display of claim 24, wherein the slope angle of the sloped reflective sidewall is between zero degrees and about forty-five degrees relative to a surface normal of an emission surface of the light guide, the slope angle being configured to preferentially scatter light in a direction of the emission surface of the light guide and away from a surface of the light guide opposite to the emission surface.

32. The static multiview display of claim 24, wherein a micro-slit scattering element of the micro-slit scattering element plurality has a curved shape in a direction that is both orthogonal to the propagation direction of the guided light and parallel to a plane of a surface of the light guide, the curved shape being configured to control emission pattern of scattered light in a plane orthogonal to a propagation direction of the guided light.

33. The static multiview display of claim 24, wherein the guided light is collimated according to a predetermined collimation factor, an emission pattern of the directional light beams being a function of the predetermined collimation factor of the guided light.

34. The static multiview display of claim 24, further comprising a light source at an input location on the light guide, the light source being configured to provide within the light guide the guided light comprising a plurality of guided light beams having different radial directions from one another, wherein different micro-slit scattering elements of the micro-slit scattering element plurality are aligned with and configured to scatter out guided light from different guided light beams of the guided light beam plurality having the different radial directions within the light guide.

35. A static multiview display comprising:
a light guide configured to guide light as a plurality of guided light beams in a fan-shaped pattern, guided light beams of the guided light beam plurality having different radial directions from one another within the light guide; and
a plurality of micro-slit scattering elements configured to emit directional light beams representing view pixels of a static multiview image, each micro-slit scattering element of the micro-slit scattering element plurality comprising a sloped reflective sidewall and being configured to provide from a portion of a guided light beam of the guided light beam plurality a directional light beam having an intensity and a direction corresponding to a relative intensity and a view direction of a view pixel of the static multiview image that corresponds to the micro-slit scattering element.

36. The static multiview display of claim 35, wherein the sloped reflective sidewall of each of the micro-slit scattering elements has a predetermined reflectivity characteristic determined by one or both of a depth of the sloped reflective sidewall and a surface reflectivity of a surface of the sloped reflective sidewall that is configured to determine the relative intensity of a directional light beam corresponding to the micro-slit scattering element, and wherein each of the micro-slit scattering elements of the microslit scattering element plurality has a predetermined rotation angle relative to a radial direction of a guided light beam corresponding to the micro-slit scattering element that is configured to determine the direction of the directional light beam.

37. The static multiview display of claim 35, wherein a micro-slit scattering element of the micro-slit scattering element plurality is one of disposed on an emission surface of the light guide and disposed below the emission surface, the micro-slit scattering element extending into an interior of the light guide away from the emission surface.

38. The static multiview display of claim 35, wherein a micro-slit scattering element of the micro-slit scattering element plurality is disposed in a light guide material layer located on a surface of the light guide, a surface of the light guide material layer being an emission surface of the static multiview display and the micro-slit scattering element extending away from an emission surface and toward the surface of the light guide.

39. The static multiview display of claim 35, further comprising a light source configured to provide within the light guide the plurality of guided light beams having the different radial directions from one another.

40. A method of static multiview display operation, the method comprising:
guiding light in a propagation direction as guided light along a length of a light guide; and
reflecting the guided light out of the light guide as a corresponding plurality of directional light beams using a plurality of micro-slit scattering elements,
the directional light beams encoding view pixels of a static multiview image and each micro-slit scattering element of the micro-slit scattering element plurality providing a different one of directional light beams having a relative intensity and a direction of a corresponding view pixel of a static multiview image,
wherein the micro-slit scattering elements each comprise a sloped reflective sidewall having a slope angle that is tilted away from the propagation direction of the guided light.

41. The method of static multiview display operation of claim 40, wherein the sloped reflective sidewall reflectively scatters light according to total internal reflection to reflect a portion of the guided out of the light guide and provide the directional light beam.

42. The method of static multiview display operation of claim 40, wherein the slope angle of the sloped reflective sidewall is between zero degrees and forty-five degrees relative to a surface normal of an emission surface of the light guide, the slope angle being chosen in conjunction with a non-zero propagation angle of the guided light to preferentially scatter light in a direction of the emission surface of the light guide and away from a surface of the light guide opposite to the emission surface.

43. The method of static multiview display operation of claim 40, the method further comprising:
providing light to be guided by the light guide using a light source,
the light source providing within the light guide the guided light comprising a plurality of guided light beams having different radial directions from one another,
wherein different micro-slit scattering elements of the micro-slit scattering element plurality are aligned with and reflect out guided light from different guided light beams of the guided light beam plurality having the different radial directions within the light guide.
